(19) United States
(12) Patent Application Publication
(10) Pub. No.: US 2019/0026742 A1
(43) Pub. Date: Jan. 24, 2019

(54) ACCOUNTING FOR UNCERTAINTY WHEN CALCULATING PROFIT EFFICIENCY

(71) Applicant: MICROSOFT TECHNOLOGY LICENSING, LLC, Redmond, WA (US)

(72) Inventors: Jayaram NM Nanduri, Issaquah, WA (US); Shoou-Jiun Wang, Sammamish, WA (US); Mohammad Mohsen Minaei Bidgoli, West Lafayette, IN (US)

(21) Appl. No.: 15/655,452

(22) Filed: Jul. 20, 2017

(51) Int. Cl. G06Q 20/40; G06Q 40/00

(52) U.S. Cl. CPC G06Q 20/4016; G06Q 40/12

(57) ABSTRACT

Embodiments herein are related to selecting one or more cutoff values used to determine if a plurality of data transactions should be accepted or rejected. In the embodiments, various data sets from a plurality of data transactions are generated. At least one of the data sets includes a different subset of the data transactions than a second data set. One or more cutoff values for each of the data sets are determined. The cutoff values specify if the data transactions are to be accepted or rejected. An efficiency value for each of the data sets is determined at each of the cutoff values. An average efficiency value and an efficiency standard deviation value at each of the cutoff values are determined based on the determined efficiency values. At least one of the cutoff values is selected based on the average efficiency value and the efficiency standard deviation value.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been, and are being, developed in all shapes and sizes with varying capabilities. As such, many individuals and families alike have begun using multiple computer systems throughout a given day.

For instance, computer systems are now used in ecommerce and the like as individuals increasing perform financial transactions such as making a purchase from various vendors over the Internet. In order to perform the financial transactions, the individuals are typically required to provide a payment instrument such as a credit card or bank account information such as a checking account to the vendor over the Internet. The vendor then uses the payment instrument to complete the transaction.

The process of providing the payment instrument over the Internet leaves the various merchants subject to loss from fraudulent transactions. For example, when a fraudulent payment instrument is used to purchase a product, the merchants often loses the costs associated with the product. This is often because the bank or financial institution that issues the payment instrument holds the merchants responsible for the loss since it was the merchants who approved the transaction at the point of sale where payment instrument is not present.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments herein are related to system, methods, and computer readable media for selecting one or more cutoff values used to determine if a plurality of data transactions should be accepted or rejected. In the embodiments, various data sets from a plurality of data transactions are generated. At least one of the data sets includes a different subset of the data transactions than a second data set. One or more cutoff values for each of the data sets are determined. The cutoff values specify if the data transactions are to be accepted or rejected. An efficiency value for each of the data sets is determined at each of the cutoff values. An average efficiency value and an efficiency standard deviation value at each of the cutoff values are determined based on the determined efficiency values. At least one of the cutoff values is selected based on the average efficiency value and the efficiency standard deviation value.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing system in which the principles described herein may be employed;

FIG. 2 illustrates a computing system that may implement the embodiments disclosed herein;

FIGS. 3A and 3B illustrate an embodiment of the operation of at least some of the elements of the computing system of FIG. 2;

FIGS. 4A-4C illustrate the operation of an uncertainty module in accordance with the embodiments disclosed herein; and

FIG. 5 illustrates a flow chart of an example method for selecting one or more cutoff values used to determine if a plurality of data transactions should be accepted or rejected.

### DETAILED DESCRIPTION

Embodiments herein are related to system, methods, and computer readable media for selecting one or more cutoff values used to determine if a plurality of data transactions should be accepted or rejected. In the embodiments, various data sets from a plurality of data transactions are generated. At least one of the data sets includes a different subset of the data transactions than a second data set. One or more cutoff values for each of the data sets are determined. The cutoff values specify if the data transactions are to be accepted or rejected. An efficiency value for each of the data sets is determined at each of the cutoff values. An average efficiency value and an efficiency standard deviation value at each of the cutoff values are determined based on the determined efficiency values. At least one of the cutoff values is selected based on the average efficiency value and the efficiency standard deviation value.

One embodiment is related to e-commerce and the like. E-commerce fraud costs retailers approximately $4 billion each year. Since E-commerce is a “card not present” scenario, merchants are responsible for fraudulent loss: merchants need to return the collected fund to card issuing banks, which is known as chargeback, when card holders report the transactions are fraudulent (unauthorized usage).

To control fraud costs, traditionally, financial instruments and credit card issuing banks use chargeback rate as the measurement to evaluate the performance of Fraud Control. Since this metric penalizes missing frauds (false negatives) heavily, the strategies developed to improve chargeback rate tend to over protective and only approve very low risk transactions. As the result, many good transactions are rejected (false positives). Currently, in general, chargeback rate is lower than 1% while issuing banks reject higher than 15% of transactions. In the field of statistical classification in Machine Learning, more comprehensive measurements (e.g., accuracy, recall or false positive rate) are introduced in a table of confusion (sometimes also called a confusion matrix). Unfortunately, those measurements can be misleading when fraud attacks happen. They also do not take margin and cost of goods into the consideration, which are essential since the business goal is often to take the approach which can maximize net profit.

Some of the embodiments disclosed herein use Profit Efficiency (PE) as the standard measurement for Fraud Control. Some advantages this leads to is are: 1. Maximizing profit efficiency leads to the strategies which yield maximal profit. For goods with higher cost and lower margin, the risk enforcement is more intensive and, other the other hand, for goods with lower cost and higher margin, there is more willingness to take risk with a lighter risk enforcement. 2. Unlike other measurements which might be misleading when the business is under severe fraud attacks, profit efficiency honestly reflects the fact and shows the loss. 3. Optimizing profit efficiency is very straightforward when compared with other systems and methods.

There are various technical effects and benefits that can be achieved by implementing aspects of the disclosed embodiments. By way of example, it is now possible to use a profit margin of a transaction as a criterion for fraud detection. It is further possible to determine the ratio of an achieved benefit such as an achieved profit to a maximum achievable benefit such as a maximum achievable profit and to use this ratio to determine how efficiently data transactions are rejected and accepted. The ratio may also be used to select a threshold or cutoff for accepting or rejecting data transactions. Further, the technical effects related to the disclosed embodiments can also include improved user convenience and efficiency gains.

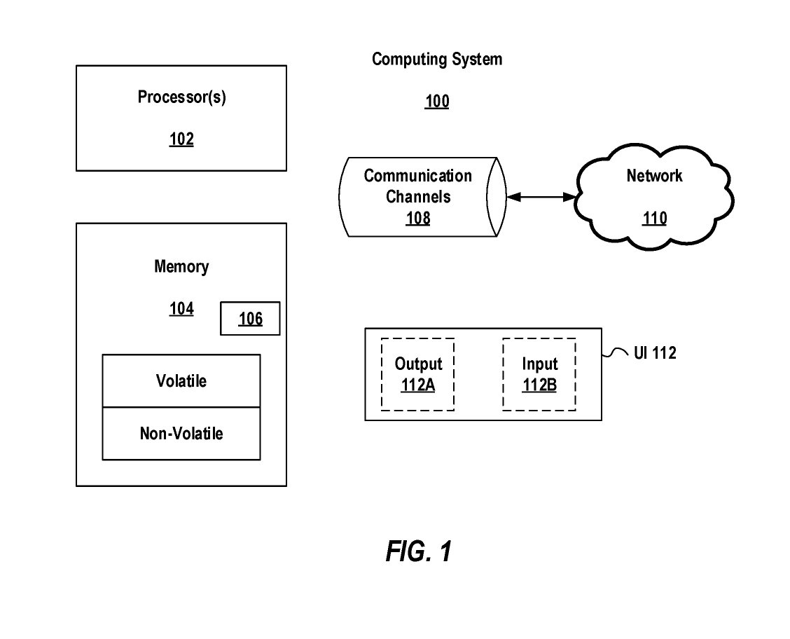

Some introductory discussion of a computing system will be described with respect to FIG. 1. Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface system 112 for use in interfacing with a user. The user interface system 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

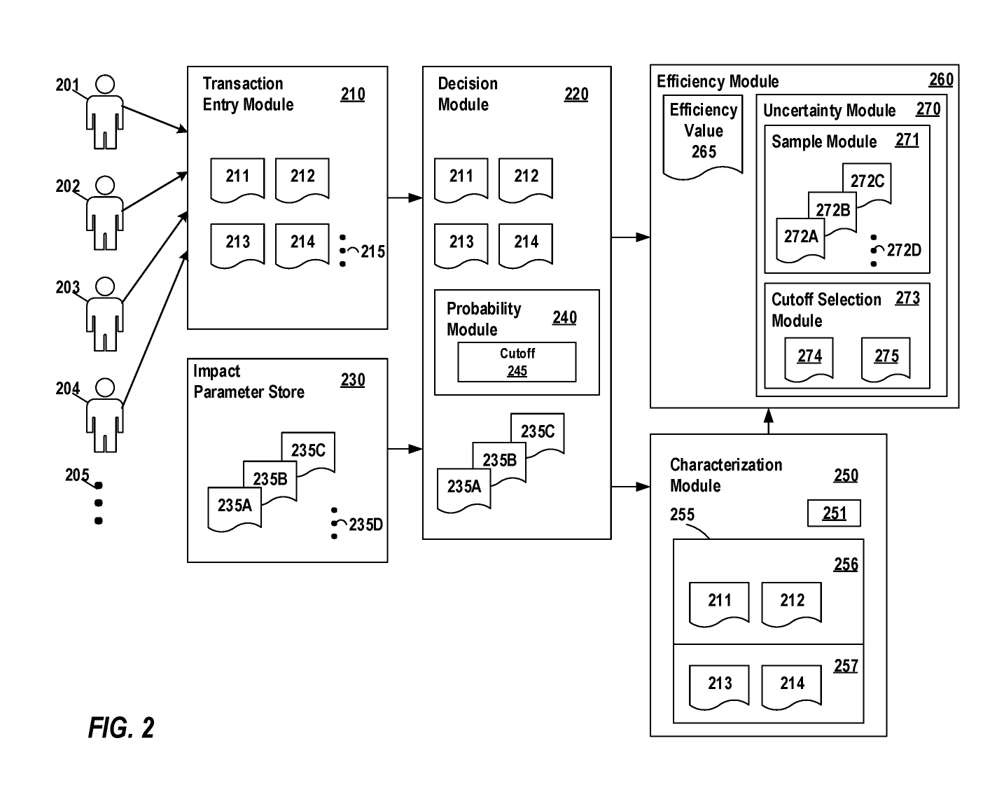

Attention is now given to FIG. 2, which illustrates an embodiment of a computing system 200, which may correspond to the computing system 100 previously described. The computing system 200 includes various components or functional blocks that may implement the various embodiments disclosed herein as will be explained. The various components or functional blocks of computing system 200 may be implemented on a local computing system or may be implemented on a distributed computing system that includes elements resident in the cloud or that implement aspects of cloud computing. The various components or functional blocks of the computing system 200 may be implemented as software, hardware, or a combination of software and hardware. The computing system 200 may include more or less than the components illustrated in FIG. 2 and some of the components may be combined as circumstances warrant. Although not necessarily illustrated, the various components of the computing system 200 may access and/or utilize a processor and memory, such as processor 102 and memory 104, as needed to perform their various functions.

As shown in FIG. 2, the computing system 200 may include a transaction entry module 210. In operation, the transaction module 210 may receive input from multiple users 201, 202, 203, 204, and any number of additional users as illustrated by the ellipses 205 to initiate a data transaction that is performed by the computing system 200. For example, the user 201 may initiate a data transaction 211, the user 202 may initiate a data transaction 212, the user 203 may initiate a data transaction 213, and the user 214 may initiate a data transaction 204. The ellipses 215 represent any number of additional data transactions that can be initiated by one or more of the users 205. Of course, it will be noted that in some embodiments a single user or a number of users less than is illustrated may initiate more than one of the transactions 211-215.

The data transactions 211-215 may represent various data transactions. For example, as will be explained in more detail to follow, the data transactions 211-215 may be purchase or other financial transactions. In another embodiments, the transactions 211-215 may be transactions related to clinical or scientific research results. In still, other embodiments, the transactions 211-215 may be any type of transaction that is able to be characterized as being properly accepted, improperly accepted, properly rejected, or improperly rejected. Accordingly, the embodiments disclosed herein are not related to any type of data transactions. Thus, the embodiments disclosed herein relate to more than purchase or financial transactions and should not be limited or analyzed as only being related to purchase or financial transactions.

The transaction entry module 210 may receive or determine information about each of the data transactions 211-215. For example, if the data transactions 211-215 are purchase or other financial transactions, then the transaction entry module 210 may determine personal information about the user, payment information such as a credit or debit card number, and perhaps the product that is being purchased. If the data transactions are clinical or scientific research data transactions, then the data transaction entry module 210 may determine identifying information about the research such as participant information and result information. The transaction entry module 210 may receive or determine other information about other types of data transactions as circumstances warrant.

The computing system 200 also includes a decision module 220. In operation, the decision module 220 may determine if each of the data transactions 211-215 is to be accepted (i.e., the data transactions are performed or completed) or if the transactions are to be rejected (i.e., the data transactions are not completed or performed). In some embodiments, the decision module 220 may perform a decision analysis on each of the data transactions. This decision analysis may be based on various factors that are indicative of whether a data transaction should be accepted or rejected.

For example, if data transaction is the purchase or other financial transaction, the factors may be related to risk analysis. For instance, the decision module 220 may determine based on the information determined by the data transaction entry module 210 that a purchase or other financial transaction is likely to be a fraudulent transaction and so the transaction may be rejected. Alternatively, this information may cause the decision module 220 to determine that the purchase or other financial transaction is likely to be a good transaction and so the transaction may be accepted.

If the data transaction is related to the clinical or scientific research results, the factors may be related to what type of errors have occurred. For example, in many research embodiments, there are Type I errors and Type II errors. The decision module 220 may accept a certain percentage of Type I errors and reject the rest and may also accept a certain percentage of Type II errors and reject the rest. In embodiments related to other types of data transactions, the decision module 220 may use other factors as circumstances warrant.

In some embodiments, the decision analysis may be based at least in part on one or more impact parameters that are related to the data transactions. For example, as illustrated in FIG. 2, the computing system may include an impact parameter store 230. Although shown as being an independent, the impact parameter store 230 may be part of another element of the computing system 200.

As shown, the impact parameter store 230 may include a first impact parameter 235a, a second impact parameter 235b, a third impact parameter 235c, and any number of additional impact parameters as illustrated by the ellipses 235d. The impact parameters may be also be referred to hereinafter as impact parameters 235.

In the embodiment related to the purchase or other financial transaction, the impact parameters 235 may be related to the product or service being purchased. For example, the first impact parameter 235a may specify a purchase price for the product or service, the second impact parameter 235b may specify the Cost of Goods Sold (COGS), and a third impact parameter 235c may specify a benefit result such as a profit margin for each transaction. As is known, the COGS typically specifies the costs of manufacturing and marketing a product as well as the cost of other factors such as customer loyalty, revenue sharing, and general business operating costs. Accordingly, the benefit result of a transaction that is properly accepted would be the purchase price minus the COGS. Other impact parameters 235d such as location of the data transaction may also be used.

Accordingly, while performing the decision analysis, the decision module 220 may base the decision at least in part on the impact parameters 235. For example, if transaction 211 includes a high purchase price and a high COGS, then the decision module 220 may be more likely to reject the transaction 211 than a data transaction 212 that has a low purchase price and low COGS. As will be noted, there is more risk to a data transaction with the high purchase price and COGS since the cost of a fraudulent transaction to the seller of the goods or service is much higher than for a data transaction with a low purchase price and low COGS.

In the embodiment related to the to the clinical or scientific research results, the impact parameters 235 may specify the amount of error that is acceptable, the research goals, and other relevant factors. These may be used by the decision module 220 as needed. In other embodiments, various other impact parameters 235 may be used as needed by the decision module 220.

In some embodiments, the decision module 220 may include or otherwise have access to a probability module 240. In operation, the probability module 240 may, based on the decision analysis, determine the probability of whether each of the data transactions 211-215 should be rejected or not. In other words, the probability is a risk probability indicative of whether a given data transaction is a good transaction that should be accepted (i.e., lower risk of being fraudulent) or is a fraudulent or bad transaction that should be rejected (i.e., high risk of being fraudulent).

The probability module 240 may access or include a cutoff or threshold value 245 that may be set by the owner of the computing system 200. The cutoff value 245 may be used to help determine if a data transaction is accepted or rejected. For example, if the probability is above the cutoff value 245, then the data transaction may be rejected while if the probability is below the threshold or cutoff value, the data transaction may be accepted. In other words, the cutoff 245 may correspond to a probability value that is deemed as being the highest acceptable risk such that any probability value above the cutoff 245 is deemed as likely to be fraudulent and therefore should be rejected as being too risky. Accordingly, any data transaction having a probability above the cutoff 245 is rejected while those below are accepted.

As will be explained in more detail to follow, the cutoff value 245 may be adjusted as needed to find an acceptable balance between the number of data transactions to accept and the amount of risk that should be incurred while accepting the data transactions. In other words, if the cutoff value 245 is set too low so as to minimize risk, too many good transactions will be rejected and if the cutoff value is set too high so as to maximize the number of data transactions that are allowed to thereby potentially increase the benefit from the transaction, too many bad transactions may be allowed, which may diminish any benefit.

As further shown in FIG. 2, the computing system 200 includes a characterization module 250. In operation, the characterization module 250 generates a characterization 255 for each of the data transactions 211-215. As will be explained in more detail to follow, the characterization 255 may be based on whether a data transaction has been accepted or rejected and based on the actual results of the data transaction if performed or completed. That is, if a data transaction was accepted, based on the decision analysis previously described, then the data transaction may be characterized as being part of first portion or group and if the data transaction was rejected, then the data transaction may be characterized as being part of a second portion or group. This is shown in FIG. 2, where the data transactions 211 and 212 are part of a first portion or group 256 and the data transactions 213 and 214 are part of a second portion or group 257. In some embodiments, the first portion or group 211 may be above the cutoff value 245 and the second portion or group may be below the cutoff value 245.

In some embodiments, the characterization module may characterize the data transactions 211-215 as being one of a “true negative”, a “false negative”, a “true positive”, and a “false positive”. In such embodiments, a true negative is a data transaction that is correctly accepted, a false negative is a data transaction that was incorrectly accepted, a false positive is a data transaction that was incorrectly rejected, and a true positive is a data transaction that was correctly rejected. It will be noted that it is desirable to maximize the number of true negatives and true positives, while minimizing the number of false positives and false negatives. In those embodiments implementing the cutoff value 245, good data transactions above the threshold are the false positives and below the threshold are the true negatives, while bad data transactions above the cutoff are the true positives and below the threshold are the false negatives.

As will be appreciated, those data transactions, such as data transactions 213 and 214 in the second portion or group 257, which were accepted may be performed by the computing system 200. Thus, in the embodiment where the data transactions are a purchase or other financial transaction the computing system 200 may perform the purchase by receiving payment from the user and then providing the product or service to the user. In such case, the characterization module 250 is able to determine if a data transaction of the second portion 257 is a true negative if the purchase or financial transaction was properly accepted, that is if the user actually paid for the product. The characterization module 250 is also able to determine if a data transaction of the second portion 257 was a false negative, which is if the user provided a fraudulent payment instrument and did not pay.

However, since the data transactions such as data transaction 211 and 212 that are in the first portion or group 256 are rejected by decision module 220, they are not actually performed or completed by the computing system 200. Accordingly, to determine if these transactions should be characterized as false positives or true positives, the characterization module 250 may include or otherwise have access to a sampling module 251. In operation, the sampling module 251 randomly accepts a subset of the data transactions in the first portion 256 so that the data transactions in the subset are allowed to be accepted. The sampling module 251 may then sample this subset to determine the outcome of the data transaction.

For example, in the embodiment where the data transactions are a purchase or other financial transaction, the sampling module 250 may determine how many data transactions in the subset were properly completed, that is the user paid for the product. Since these were successful data transactions, they are characterized as false positives since were improperly rejected. Likewise, the sampling module 251 will determine how many data transactions in the subset were not properly completed, that is the user paid for the product by a fraudulent means. Since these data transactions were properly rejected, they are characterized as true positives. The sampling module 251 may then use statistical analysis based on the subset to characterize the remaining data transactions of the first portion 256. Since the data transactions in the first portion 256 were all rejected by the decision module 220 in the manner previously described, it is likely that many in the subset will be fraudulent transaction if they are completed. Accordingly, the subset should be only be large enough to adequately represent all of the data transactions in the first portion 256 to thereby cut down on the potential costs of the fraudulent transactions in the subset.

The computing system 200 may also include an efficiency module 260. In one embodiment, the efficiency module 260 may be a machine learning classifier that is able to employ machine learning to perform an efficiency analysis of the decision of the computing system 200 to accept or reject the data transactions 211-215. In some embodiments, the efficiency analysis may determine how efficiently each of the data transactions was included in the first and second portions 256 and 257 based at least partially on the one or more of the impact parameters 235. In other embodiments, the efficiency analysis may determine how efficiently the data transactions are accepted or rejected based on a benefit result such as the benefit result 235c and based on the cutoff 245. It will be appreciated that one or more of the other components of the computing system 200 may also implement machine learning as circumstances warrant.

In operation, the efficiency module 260 may receive the impact parameters 235 and the decision analysis from the decision module 220. In addition, the efficiency module 260 may receive the characterization 255 of each of the data transactions from the characterization module 250.

The efficiency module 260 may perform an overall result analysis to determine a result that would occur if all “good” data transactions that should be accepted were accepted. In this way, the efficiency module 260 is able to ascertain the benefit of the false positives that should have been accepted, but that are rejected. For example, in the embodiment where the data transactions are purchase or other financial transactions, the benefit may be the profit obtained from the false positives and the true negatives. In the embodiment related to the clinical or scientific research results, the benefit may be results that otherwise would not have been considered.

The efficiency module 260 may also perform an impact analysis of the false negatives on the data transactions that were accepted. In some embodiments, this is done by having the efficiency module 260 subtract or otherwise remove a cost of the false positives from a benefit of the accepted true negatives. In this way, the efficiency module 260 may determine actual benefit achieved. For example, in the embodiment where the data transactions are purchase or other financial transactions, the cost of a product that was obtained fraudulently by a false negative transaction may be subtracted from the profit gained from the true negative transaction. In the embodiment related to the clinical or scientific research results, the costs of results that should not have been considered may be subtracted from the benefits of the results that should be considered.

The efficiency module 260 may also perform an efficiency analysis that finds a ratio of the impact of the false negatives on the accepted true negatives to the overall result. The resulting ratio will be an efficiency value or percentage 265 that specifies how efficiently the data transactions are rejected and accepted and how efficiently the cutoff value 245 is selected. As will be appreciated, if the efficiency value 265 is a high value, it is likely the computing system is efficiently accepting and rejecting the data transactions. However, if the efficiency value 265 is a low value, it is likely the computing system is not efficiently accepting and rejecting the data transactions. In such cases, adjustments may be made to where the cutoff value 245 is made.

In one embodiment, the efficiency analysis may be characterized by the following equation (1) that determines the efficiency value 265:

$$\frac{Benefit acheived}{Maximum Benefit Acheivable} = \frac{Benefit ( True Negative ) - Cost ( False Negative )}{Benefit ( True Negative ) + Benefit ( False Positive )}$$

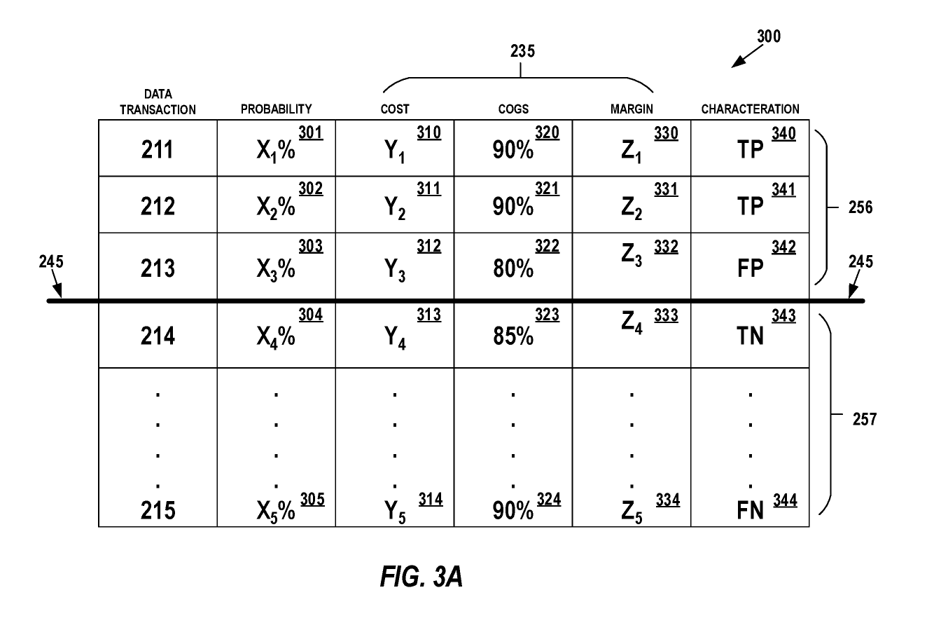

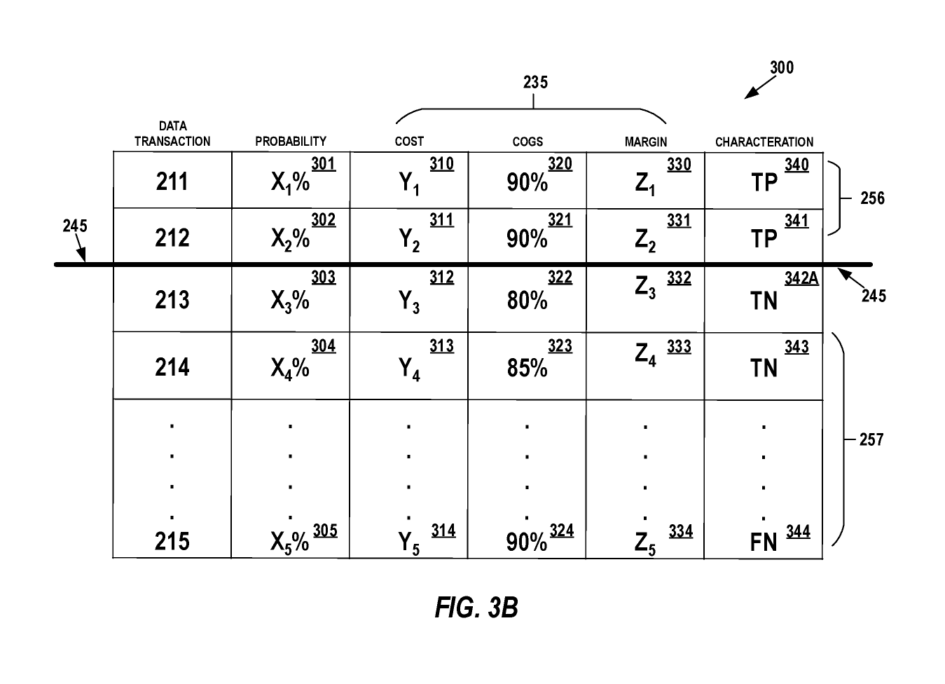

A specific example of the operation of the computing system 200 and in particular the operation of the efficiency module 260 will now be explained with reference to the embodiment of the data transactions being a purchase or other financial transaction. FIG. 3A shows a table 300 that may be used to help simply the explanation. It will be noted that the use of the table 300 for explanation purposes is not meant to imply that the computing system 200 produces such a table, although in some embodiments such a table may be produced. It will also be noted that FIG. 3A will use the same reference numbers as those used in FIG. 2 for like elements. It will further be noted that the ellipses shown in FIG. 3A represent that there will typically be a large number of data transactions in the embodiments, usually in the hundreds of thousands.

As shown in FIG. 3A, the data transaction 211 was determined by the probability module 240 to have a probability 301 of X1% of being a fraudulent transaction. The data transaction 211 includes a cost 310 of Y1, a COGS 320 of 90%, and a profit margin 330 of Z1, which is determined by finding the difference between the cost 310 and the COGS 320. As described above, the cost 310, the COGS 320, and the margin 330 are examples of impact parameters 335 related to the data transaction 211. In addition, the profit margin 330 is an example of a benefit value 235c.

The data transaction 212 was determined by the probability module 240 to have a probability 302 of X2% of being a fraudulent transaction. The data transaction 212 includes a cost 311 of Y2, a COGS 321 of 90%, and a profit margin 331 of Z2, which is determined by finding the difference between the cost 311 and the COGS 321. As described above, the cost 311, the COGS 321, and the margin 331 are examples of impact parameters 335 related to the data transaction 212. In addition, the profit margin 331 is an example of a benefit value 235c.

The data transaction 213 was determined by the probability module 240 to have a probability 303 of X3% of being a fraudulent transaction. The data transaction 213 includes a cost 312 of Y3, a COGS 322 of 80%, and a profit margin 332 of Z3, which is determined by finding the difference between the cost 312 and the COGS 322. As described above, the cost 312, the COGS 322, and the margin 332 are examples of impact parameters 335 related to the data transaction 213. In addition, the profit margin 332 is an example of a benefit value 235c.

The data transaction 214 was determined by the probability module 240 to have a probability 304 of X4% of being a fraudulent transaction. The data transaction 214 includes a cost 313 of Y4, a COGS 323 of 85%, and a profit margin 333 of Z4, which is determined by finding the difference between the cost 313 and the COGS 323. As described above, the cost 313, the COGS 323, and the margin 333 are examples of impact parameters 335 related to the data transaction 214. In addition, the profit margin 333 is an example of a benefit value 235c.

The data transaction 215 was determined by the probability module 240 to have a probability 305 of X5% of being a fraudulent transaction. The data transaction 215 includes a cost 314 of Y5, a COGS 324 of 90%, and a profit margin 334 of Z5, which is determined by finding the difference between the cost 314 and the COGS 324. As described above, the cost 314, the COGS 324, and the margin 334 are examples of impact parameters 335 related to the data transaction 215. In addition, the profit margin 334 is an example of a benefit value 235c.

FIG. 3A also shows that the decision analysis of the decision module 220 determines that any transaction with a probability of X1%-X3% should be rejected, which in this case includes data transactions 211, 212, and 213. This is illustrated by the cutoff value 245 being located between data transaction 213 and 214 (i.e., a value between the probabilities X3% and X4%). Accordingly, the data transactions 211-213 are included in the first portion 256 and the remaining data transactions are included in the second portion 237.

Once the cutoff value 245 has been set, the characterization module 250 may characterize each of the data transactions based on if they were accepted or not in the manner previously described. In FIG. 3A, the data transaction 211 is characterized as a true positive (TP 340), the data transaction 212 is characterized as a true positive (TP 341), the data transaction 213 is characterized as a false positive (FP 342), the data transaction 214 is characterized as a true negative (TP 343), and the data transaction 215 is characterized as a false negative (FN 344).

The efficiency module 260 may perform the efficiency analysis to determine how efficiently the computing system has accepted or rejected the data transactions. For example, the efficiency module 260 may determine by the overall result analysis the overall achievable profit margins (i.e., margin 333) of all the true negative data transactions (i.e., 214) added to the margins (i.e., margin 332) of all the false positive data transactions (i.e., 213). That is, the total profit achievable is the profit that is gained by the true negative data transactions and the profit that would have be gained had the false positive transactions not been improperly rejected.

Likewise the efficiency module 260 may determine by the impact analysis the impact of the false negatives on the accepted transactions. This may be done by subtracting the COGS of the false negative transactions (i.e., 215) from the margins (i.e., margin 333) of all the true negative data transactions (i.e., 214). That is, the costs of the false negative transactions are subtracted from the profits of the true negative transactions.

The efficiency module 260 perform the efficiency analysis to determine a ratio of the impact of the false negatives to the overall result. In the given example, the efficiency analysis may be characterized by the following equation (2):

$$\frac{Profit Acheved}{Maximum Profit Acheivable} = \frac{Margin ( True Negative ) - GOGS ( False Negative )}{Margin ( True Negative ) + Margin ( False Positive )}$$

The ratio will be an example of an efficiency value 265 that will specify how well the computing system has accepted or rejected the data transactions. As will be appreciated, if the value 265 is high, then the computing system is likely doing a good job of maximizing profit by accepting a large percentage of transactions that should be accepted and rejecting a large percentage of transactions that should be rejected. However, if the value 265 is low, then it is likely that the computing system is not doing a good job or maximizing profits as too many transactions that should be accepted are rejected and too many transactions that should be rejected are accepted.

FIG. 3B illustrates an example of adjusting the location of the cutoff value 245 to change the profit efficiency of the computing system 200. In FIG. 3B, most of the elements are the same as that of FIG. 3A and so only the changes will be explained.

As shown, the cutoff value 245 has been moved to be between the data transactions 212 and 213 (i.e., a value between the probabilities X2% and X3%). The change in the cutoff value 245 causes the characterization of the data transaction 213 to become a true negative (TN 342a). That is, since the data transaction 213 is now an accepted transaction, it is a true negative since it was a good transaction that was properly accepted.

The efficiency module 260 may perform the efficiency analysis in the manner previously described using the equation 2 to determine the efficiency value 265. In this case, the efficiency value 265 will increase since there is now a larger profit margin associated with the true negatives. Accordingly, in the embodiment a larger profit or benefit is achieved by setting the cutoff value 245 as shown in FIG. 3B over setting the cutoff value 245 as shown in FIG. 3A.

FIGS. 3A and 3B illustrate that the efficiency module 260 is able to learn by continually evaluating how efficiently the computing system 200 determines how to accept or reject the data transactions and where to place the cutoff value 245. The efficiency value 265 may be used by the efficiency module 260 to help the computing system 200 determine where to set the cutoff 245. This may be tracked over a period of time so that it may ascertained if the computing system 200 is improving its maximizing of profit by accepting most of the data transactions that should be accepted and rejecting most of the data transactions that should be rejected.

As discussed previously, the cutoff value 245 may be changed as needed to increase the efficiency value 265. This will often lead to the selection of a cutoff value 245 that will maximize the efficiency value 265. However, in many embodiments as the data transactions 211-215 change over time, natural variations may creep into the data. For example, the data transactions collected during the month of February may be include variations from the data transactions collected during the month of March, even for similar types and numbers of transactions. If there is a large variance, it is possible that uncertainty in introduced into the efficiency value analysis, which may lead to unexpected results. Thus, in many embodiments simply selecting of a cutoff value 245 that will maximize the efficiency value 265 may not account for this uncertainty.

Accordingly, the efficiency module 260 may also include an uncertainty module 270. In operation, the uncertainty module 270 may determine efficient cutoff values 245 based on efficiency values for various samples of the data transactions. Use of these cutoff values will then take any uncertainty (or at least a portion of any uncertainty) into account when determining if a data transaction should be accepted or rejected. The operation of the uncertainty module 270 will now be explained.

As illustrated, the uncertainty module 270 may include a sample module 271. In operation, the sample module 271 may generate a number of sample data sets 272A, 272B, 272C and any number of additional data sets as illustrated by the ellipses 272D from the data transactions 211-215. In order to simulate the natural variance that may occur between data transactions over time, each of the data sets 272 may include a different set of the data transactions 211-215, while all being the same size. The sample module 271 may also specify all possible cutoff values 245 for each of the data sets as will be explained in more detail to follow.

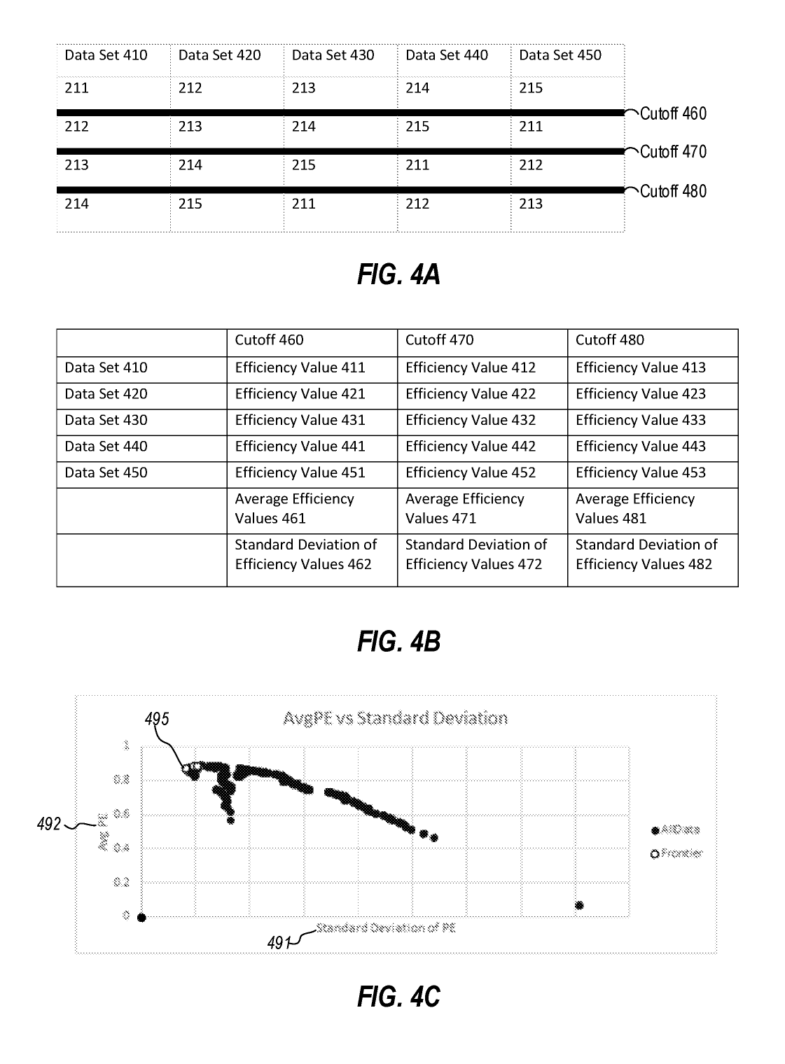

FIG. 4A illustrates an embodiment of the operation of the sample module 271. As illustrated, FIG. 4A shows a data set 410, a data set 420, a data set 430, a data set 440, and a data set 450, all of which may be examples of the data sets 272. It will be appreciated that while five data sets are shown in the illustrated embodiment, this ease of explanation only and that there may be any number of additional data sets.

As explained previously, in order to simulate the natural variance that may occur between data transactions over time, each of the data sets 410-450 include different sets of data transactions. For example, data set 410 may include data transactions 211, 212, 213, and 214, data set 420 may include data transactions 212, 213, 214, and 215, data set 430 may include data transactions 213, 214, 215, and 211, data set 440 may include data transactions 214, 215, 211, and 212, and data set 450 may include data transactions 215, 211, 212, and 213. It will be appreciated that having each data set only include four data transactions is for ease of illustration only and that the data sets 410-450 may include numerals other data transactions as circumstances warrant.

As previously mentioned, the sample module 271 may also determine all possible cutoff values 245 for the data sets. For example, as illustrated in FIG. 4A, the sample module may determine a cutoff value 460 that is between the first and second data transactions in each data set, a cutoff value 470 that is between the second and third data transactions of each data set, and a cutoff value 480 that is between the third and fourth data transactions of each data set. It will be noted that the cutoff values 460, 470, and 480 are all examples of a cutoff value 245 and may be determined in the manner previously described in relation to FIGS. 2 and 3. Accordingly, in the embodiment the data transactions above the cutoff value 460 would be rejected and the data transactions below would be accepted, the data transactions above the cutoff 470 would be rejected and the data transactions below would be accepted and the data transactions above the cutoff 480 would be rejected and the data transactions below would be accepted. As previously discussed, the selection of the cutoff value will determine which data transactions are rejected and which are accepted.

Returning to FIG. 2, the uncertainty module 270 may also include a cutoff selection module 273. In operation, the cutoff selection module causes the efficiency module 260 to determine an efficiency value 265 for each of the data sets at a given cutoff value. The efficiency values 265 may be determined in the manner previously described using equation 2 and the information in FIG. 3, although this is not required as other methods of determining an efficiency value may also be used.

Once the efficiency values 265 have been determined for each of the data sets at the cutoff values, the cutoff selection module 273 may determine an average efficiency value 274 at the cutoff value. In addition, the cutoff selection module 273 may determine a standard deviation value 275 of the efficiency values at the cutoff value. The average efficiency value 274 and the standard deviation value 275 may be determined by any reasonable means.

Once the determination of the average efficiency value 274 and the standard deviation value 275 is complete for each given cutoff value, the cutoff selection module 273 may determine one or more cutoff values 245 that should be used by the determination module 220 to determine those data transactions to reject or accept. This is done by selecting those cutoff values that have the highest average efficiency value 274 and the lowest standard deviation 275.

The operation of the cutoff selection module 273 will now be explained with reference to FIG. 4B. As illustrated in the figure, the efficiency module 260 may determine an efficiency value 265 for each data set at each of the cutoff values in the manner previously described. For example, the efficiency module 260 may determine for the cutoff value 460 an efficiency value 411 for the data set 410, an efficiency value 421 for the data set 420, an efficiency value 431 for the data set 430, an efficiency value 441 for the data set 440, and an efficiency value 451 for the data set 450. Likewise, the efficiency module 260 may determine for the cutoff value 470 an efficiency value 412 for the data set 410, an efficiency value 422 for the data set 420, an efficiency value 432 for the data set 430, an efficiency value 442 for the data set 440, and an efficiency value 452 for the data set 450. Similarly, the efficiency module 260 may determine for the cutoff value 480 an efficiency value 413 for the data set 410, an efficiency value 423 for the data set 420, an efficiency value 433 for the data set 430, an efficiency value 443 for the data set 440, and an efficiency value 453 for the data set 450. It will be appreciated that the efficiency values shown in FIG. 4B are examples of the efficiency value 265.

Once the efficiency values for each data set at each cutoff value have been determined, the cutoff selection module 273 may determine an average efficiency value 274 and a standard deviation value 275 of the efficiency values. For example, as shown in FIG. 4B the cutoff selection module 273 may determine an average efficiency value 461 and a standard deviation value 462 of the efficiency values 411, 421, 431, 441, and 451 for the cutoff value 460, an average efficiency value 471 and a standard deviation value 472 of the efficiency values 412, 422, 432, 442, and 452 for the cutoff value 470, and an average efficiency value 481 and a standard deviation value 482 of the efficiency values 413, 423, 433, 443, and 453 for the cutoff value 480. It will be appreciated that the average efficiency values 461, 471, and 481 are examples of the average efficiency value 274 and the standard deviation values 462, 472, and 482 are examples of the standard deviation value 275 and that these values may be determined in any reasonable way an average value and a standard deviation value are determined.

The cutoff selection module 273 may then select one or more of the cutoff values 460, 470, and 480 that should be used by the determination module 260 when determining which data transactions to accept or reject. In one embodiment, the cutoff selection module 273 may select the cutoff value that has the highest average efficiency value and the lowest standard deviation of efficiency values.

For example, FIG. 4C illustrates a graph 490 of various cutoff values 265 and their corresponding standard deviations (x-axis 491) and average efficiency values (y-axis 492). As can be seen in the graph, those cutoff values in the region denoted by 495 have the highest average efficiency value while also having the lowest standard deviation value. Accordingly, the cutoff selection module 273 may select one of the cutoff values in the region 495 as the cutoff value to be used by the determination module 260. In some embodiments, a higher risk strategy that desires to accept more of the data transactions may select a cutoff value on the lower left of the region 495 as these cutoff values may allow more data transactions to be accepted. A lower risk strategy, conversely, would select a cutoff value on the upper portion of the region 495 since these cutoff values would be likely to reject more of the data transactions that could be fraudulent.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

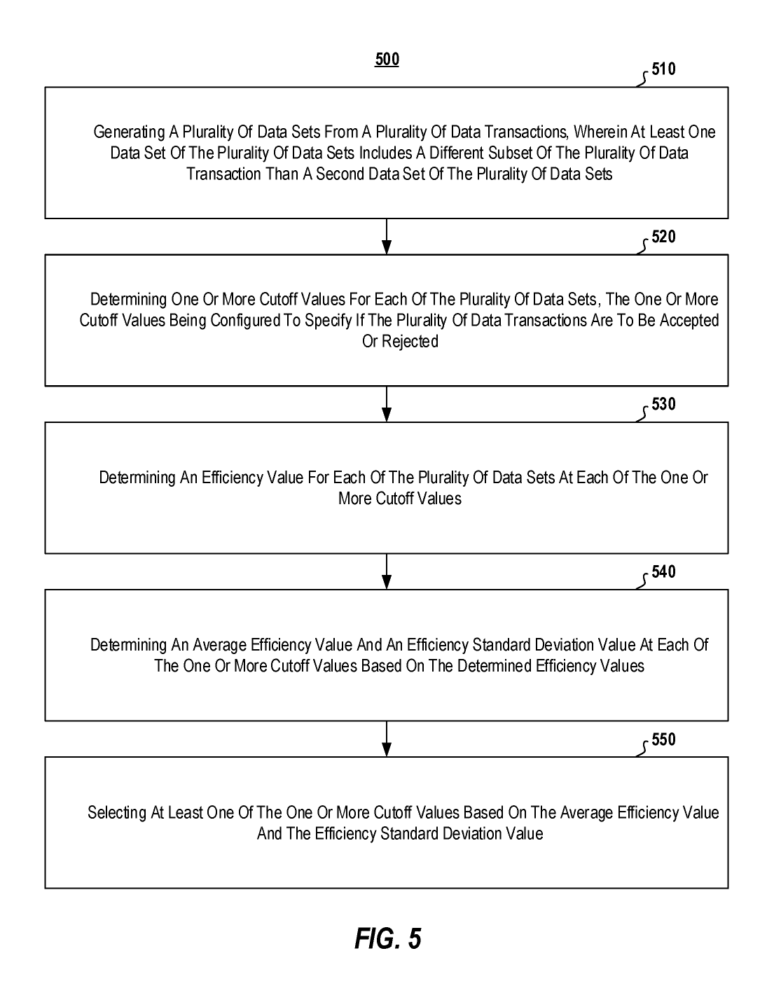

FIG. 5 illustrates a flow chart of an example method 500 for selecting one or more cutoff values used to determine if a plurality of data transactions should be accepted or rejected. The method 500 will be described with respect to one or more of FIGS. 2-4 discussed previously.

The method 500 includes generating a plurality of data sets from a plurality of data transactions (act 510). At least one data set of the plurality of data sets includes a different subset of the plurality of data transaction than a second data set of the plurality of data sets. For example, the sample module 271 may generate the data sets 272 from the data transactions 211-215. These are illustrated in FIG. 4B as data sets 410-450. In order to simulate the natural variance that may occur between data transactions over time, at least one of the data sets 272 may include a different subset of the data transactions than another of the data sets. In some embodiments, each of the data sets may include a different subset of the data transactions.

The method 500 includes determining one or more cutoff values for each of the plurality of data sets (act 520). The one or more cutoff values are configured to specify if the plurality of data transactions is to be accepted or rejected. For example, the sample module 271 may determine the possible cutoff values 245 for each of the data sets. The cutoff values are illustrated in FIGS. 4A and 4B as cutoff values 460, 470, and 480. As discussed above, the cutoff values 245 act as a threshold value so that data transactions having a probability above the cutoff are rejected and data transactions having a probability below the cutoff are accepted.

The method 500 includes determining an efficiency value for each of the plurality of data sets at each of the one or more cutoff values (act 530). For example, the efficiency module 260 may determine efficiency values 265 for each of the data sets 460-480 at each of the cutoff values. This is illustrated and described in FIG. 4B in relation to efficiency values 411, 412, 413, 421, 422, 423, 431, 432, 433, 441, 442 443, 451, 452, and 453.

The method 500 includes determining an average efficiency value and an efficiency standard deviation value at each of the one or more cutoff values based on the determined efficiency values (act 540). For example, as illustrated and described in relation to FIG. 4B, the cutoff selection module 273 may determine the average efficiency value 274 and the efficiency standard deviation value 275. This is illustrated and described in FIG. 4B in relation to average efficiency values 461, 471, and 481 and efficiency standard deviation values 462, 472, and 482.

The method 500 includes selecting at least one of the one or more cutoff values based on the average efficiency value and the efficiency standard deviation value (act 550). As previously described, the cutoff selection module 273 may select the one or more cutoff values 245 having the highest average efficiency value and the lowest standard deviation. In some embodiments, there may be region of such cutoff values and in such cases the cutoff value selected may be based on the amount of desired risk.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system for selecting one or more cutoff values used to determine if a plurality of data transactions should be accepted or rejected, the computing system comprising:
at least one processor;
a computer readable hardware storage device having stored thereon computer-executable instructions which, when executed by the at least one processor, cause the computing system to perform the following:
an act of generating a plurality of data sets from a plurality of data transactions, wherein at least one data set of the plurality of data sets includes a different subset of the plurality of data transaction than a second data set of the plurality of data sets;
an act of determining one or more cutoff values for each of the plurality of data sets, the one or more cutoff values being configured to specify if the plurality of data transactions are to be accepted or rejected;
an act of determining an efficiency value for each of the plurality of data sets at each of the one or more cutoff values;
an act of determining an average efficiency value and an efficiency standard deviation value at each of the one or more cutoff values based on the determined efficiency values; and
an act of selecting at least one of the one or more cutoff values based on the average efficiency value and the efficiency standard deviation value.

2. The computing system of claim 1, wherein the selected one of the one or more cutoff values is a cutoff value having a highest average efficiency value while also having a lowest standard deviation value.

3. The computing system of claim 1, wherein the selected one of the one or more cutoff values specify a probability that each one of the plurality of data transactions should be rejected, wherein each one of the plurality of data transactions having a probability above the selected cutoff value is rejected and each one of the plurality of data transactions having a probability below the selected cutoff value is accepted.

4. The computing system of claim 1, wherein each data set of the plurality of data sets includes a different subset of the plurality of data transactions.

5. The computing system of claim 1, wherein determining an efficiency value for each of the plurality of data sets at each of the one or more cutoff values comprises:
an act of determining a benefit result for each of the data transactions; and
an act of calculating a ratio of an achieved benefit result to a maximum achievable benefit result for the benefit results of each of the data transactions.

6. The computing system of claim 5, wherein the benefit result is a profit margin for each of the data transactions.

7. The computing system of claim 5, wherein the act of calculating a ratio of an achieved benefit result to a maximum achievable benefit result for the benefit results of each of the data transactions comprises:
determining a profit margin for each properly accepted data transaction;
subtracting a cost of each improperly accepted transaction from the profit margin of the properly accepted transactions; and
dividing by the sum of the profit margin for each properly accepted data transaction and a profit margin for each improperly rejected data transaction.

8. A computer-implemented method for selecting one or more cutoff values used to determine if a plurality of data transactions should be accepted or rejected, the method comprising:
an act of generating a plurality of data sets from a plurality of data transactions, wherein at least one data set of the plurality of data sets includes a different subset of the plurality of data transaction than a second data set of the plurality of data sets;
an act of determining one or more cutoff values for each of the plurality of data sets, the one or more cutoff values being configured to specify if the plurality of data transactions are to be accepted or rejected;
an act of determining an efficiency value for each of the plurality of data sets at each of the one or more cutoff values;
an act of determining an average efficiency value and an efficiency standard deviation value at each of the one or more cutoff values based on the determined efficiency values; and
an act of selecting at least one of the one or more cutoff values based on the average efficiency value and the efficiency standard deviation value.

9. The computer-implemented method of claim 8, wherein the selected one of the one or more cutoff values is a cutoff value having a highest average efficiency value while also having a lowest standard deviation value.

10. The computer-implemented method of claim 8, wherein the selected one of the one or more cutoff values specify a probability that each one of the plurality of data transactions should be rejected, wherein each one of the plurality of data transactions having a probability above the selected cutoff value is rejected and each one of the plurality of data transactions having a probability below the selected cutoff value is accepted.

11. The computer-implemented method of claim 8, wherein each data set of the plurality of data sets includes a different subset of the plurality of data transactions.

12. The computer-implemented method of claim 8, wherein determining an efficiency value for each of the plurality of data sets at each of the one or more cutoff values comprises:
an act of determining a benefit result for each of the data transactions; and
an act of calculating a ratio of an achieved benefit result to a maximum achievable benefit result for the benefit results of each of the data transactions.

13. The computer-implemented method of claim 12, wherein the benefit result is a profit margin for each of the data transactions.

14. The computer-implemented method of claim 12, wherein the act of calculating a ratio of an achieved benefit result to a maximum achievable benefit result for the benefit results of each of the data transactions comprises:
determining a profit margin for each properly accepted data transaction;
subtracting a cost of each improperly accepted transaction from the profit margin of the properly accepted transactions; and
dividing by the sum of the profit margin for each properly accepted data transaction and a profit margin for each improperly rejected data transaction.

15. A computer program product comprising one or more hardware storage devices having stored thereon computer executable instructions, the computer executable instructions being executable by one or more processors of a computing system to cause the computing system to perform a method for selecting one or more cutoff values used to determine if a plurality of data transactions should be accepted or rejected, the method comprising:
an act of generating a plurality of data sets from a plurality of data transactions, wherein at least one data set of the plurality of data sets includes a different subset of the plurality of data transaction than a second data set of the plurality of data sets;
an act of determining one or more cutoff values for each of the plurality of data sets, the one or more cutoff values being configured to specify if the plurality of data transactions are to be accepted or rejected;
an act of determining an efficiency value for each of the plurality of data sets at each of the one or more cutoff values;
an act of determining an average efficiency value and an efficiency standard deviation value at each of the one or more cutoff values based on the determined efficiency values; and
an act of selecting at least one of the one or more cutoff values based on the average efficiency value and the efficiency standard deviation value.

16. The computer program product of claim 15, wherein the selected one of the one or more cutoff values is a cutoff value having a highest average efficiency value while also having a lowest standard deviation value.

17. The computer program product of claim 15, wherein the selected one of the one or more cutoff values specify a probability that each one of the plurality of data transactions should be rejected, wherein each one of the plurality of data transactions having a probability above the selected cutoff value is rejected and each one of the plurality of data transactions having a probability below the selected cutoff value is accepted.

18. The computer program product of claim 15, wherein each data set of the plurality of data sets includes a different subset of the plurality of data transactions.

19. The computer program product of claim 15, wherein determining an efficiency value for each of the plurality of data sets at each of the one or more cutoff values comprises:
an act of determining a benefit result for each of the data transactions; and
an act of calculating a ratio of an achieved benefit result to a maximum achievable benefit result for the benefit results of each of the data transactions.

20. The computer program product of claim 19, wherein the act of calculating a ratio of an achieved benefit result to a maximum achievable benefit result for the benefit results of each of the data transactions comprises:
determining a profit margin for each properly accepted data transaction;
subtracting a cost of each improperly accepted transaction from the profit margin of the properly accepted transactions; and
dividing by the sum of the profit margin for each properly accepted data transaction and a profit margin for each improperly rejected data transaction.
